(19) United States
(12) Patent Application Publication
(10) Pub. No.: US 2016/0110611 A1
(43) Pub. Date: Apr. 21, 2016

(54) NUMERICAL CONTROL DEVICE

(71) Applicant: FANUC CORPORATION, Minamitsuru-gun (JP)

(72) Inventor: Satoshi HASEGAWA, Minamitsuru-gun (JP)

(21) Appl. No.: 14/876,913

(22) Filed: Oct. 7, 2015

(30) Foreign Application Priority Data
Oct. 17, 2014 (JP) 2014-212522

(51) Int. Cl. G06K 9/00; G06F 3/0489; G05B 19/4069; G11B 27/34

(52) U.S. Cl. CPC G06K 9/00744; G11B 27/34; G06F 3/0489; G05B 19/4069; G06K 2009/00738; G05B 2219/31447

(57) ABSTRACT

A numerical control device for recording status information indicating status at machine control includes, a display image generation unit configured to generate a display image, a keyboard image generation unit configured to generate a keyboard image, the keyboard image being generated by imaging acquired key depression state, an image combination unit configured to combine the display image and the keyboard image into a combined image, a moving image generation unit configured to generate a moving image based on the combined image generated periodically.

### BACKGROUND OF THE INVENTION

1. Field of the Invention

The present invention relates to a numerical control device, and more particularly to a numerical control device for imaging various kinds of log information and recording the imaged various kinds of log information with a display image of a screen as a moving image file.

2. Description of the Related Art

Functions for recording in an internal RAM or outputting to an external storage device log information such as key operation histories, alarm occurrence histories, ON/OFF state histories of a specific signal, has been proposed (For example, Japanese Patent Laid-Open No. 06-083428, Japanese Patent Laid-Open No. 63-257042, Japanese Patent Laid-Open No. 2007-272545, Japanese Patent Laid-Open No. 2005-004270).

The log information recorded by these functions are usually output as a text file. When a problem occurs with the machine movement and an operator investigates the cause, the operator estimates the cause of the problem based on the operation, signal state, state of occurrence of alarm at the time of the problem occurrence, by acquiring the log information up to the occurrence of the problem and with time series analyses of various kinds of histories.

There are cases where, when a problem occurs during screen operation of the numerical control device, the operator wants to know screen transition until the problem occurs or the screen content displayed when the problem occurs, in addition to the log information. However, even when operation history or information of the internal state is recorded in a text file, it is impossible for the operator to grasp the state of the screen from the text data, and the operator needs to suppose the state of the screen based on the log information.

In addition to that, it is necessary to retrace the log till the time of the problem generation to find the history where the state changes, for finding the state at the time of the problem occurrence, since history is recorded as the log information only when the state changes such as key depression, alarm generation, alarm disappearance, and signal change, in related arts. There is a problem that it imposes large burden on the operator to perform the work as mentioned above using the text data recorded in the log information.

Moreover, there is a problem that it is difficult to imagine the actual operation state because key operation history and ON/OFF state information of the signal of the console panel of the machine and the like are also recorded in a text file.

### SUMMARY OF THE INVENTION

In view of the above-described problems in the prior art techniques, a purpose of the present invention is to provide a numerical control device with which the operator can easily grasp the display and operation state of the numerical control device, and signal state of the console panel of the machine or the like.

A numerical control device according to the present invention is one for recording status information indicating status at machine control, the numerical control device including a display image generation unit configured to generate a display image, the display image being generated by imaging a picture to be displayed on a screen, a keyboard image generation unit configured to generate a keyboard image, the keyboard image being generated by acquiring key depression state information and imaging the acquired key depression state, an image combination unit configured to combine the display image and the keyboard image into a combined image, a moving image generation unit configured to generate a moving image based on the combined image generated periodically.

The numerical control device may further comprising at least one of, an alarm state image generation unit configured to acquire information of occurring alarm and generate an alarm state image by imaging the acquired information of occurring alarm, a signal state image generation unit configured to acquire ON/OFF state information of a signal and generate a signal state image by imaging the acquired ON/OFF state information of the signal, and an internal information image generation unit configured to acquire internal information of the numerical control device and imaging the acquired internal information of the numerical control device, wherein the image combination unit is further configured to combine at least one of the alarm state image, the signal state image, and the internal information image, with the display image and the keyboard image, to the combined image.

The moving image in each prescribed time may be recorded as a video file.

The moving image before and after occurrence of alarm may be recorded as a moving image file different from other moving image files.

The present invention, with the above mentioned configuration, stores the screen information, key operation information, alarm information, changes of a specific signal of the numerical control device, and the internal information of the numerical control device, in a moving image in time series as screen images, so various kinds of situation at the time of problem occurrence are visually grasped by replaying the moving image, bringing the effect that the operator can reduce the time to investigate the problem occurring in the numerical control device or the machine.

The present invention has an advantage that movement is easily grasped because the data is recorded as a moving image, when compared to a method of recording the screen of the numerical control device as image data, and an advantage that by far smaller size data is required and longer time record can be stored than in a method of storing more than one images for the same picture, considering the fact that codec of the moving image effectively records differential information before and after a frame.

### BRIEF DESCRIPTION OF THE DRAWINGS

The above-described object, the other object, and the feature of the invention will be proved from the description of embodiments below with reference to the accompanying drawings. In these drawings:

FIG. 1 is a schematic block diagram showing a numerical control device according to an embodiment of the present invention.

FIG. 2 is a display example of the moving image recorded by the numerical control device according to an embodiment of the present invention.

FIGS. 3A, 3B are flowcharts of the full time recording process according to an embodiment of the present invention.

FIG. 4 is a keyboard image in the moving image recorded by the numerical control device according to an embodiment of the present invention.

FIG. 5 is a signal state image in the moving image recorded by the numerical control device according to an embodiment of the present invention.

FIG. 6 is an internal state image in the moving image recorded by the numerical control device according to an embodiment of the present invention.

FIG. 7 is a diagram explaining an example of the time division moving image record according to an embodiment of the present invention.

FIG. 8 is a diagram explaining an example of the moving image record at the time of alarm occurrence according to an embodiment of the present invention.

### DETAILED DESCRIPTION OF THE PREFERRED EMBODIMENTS

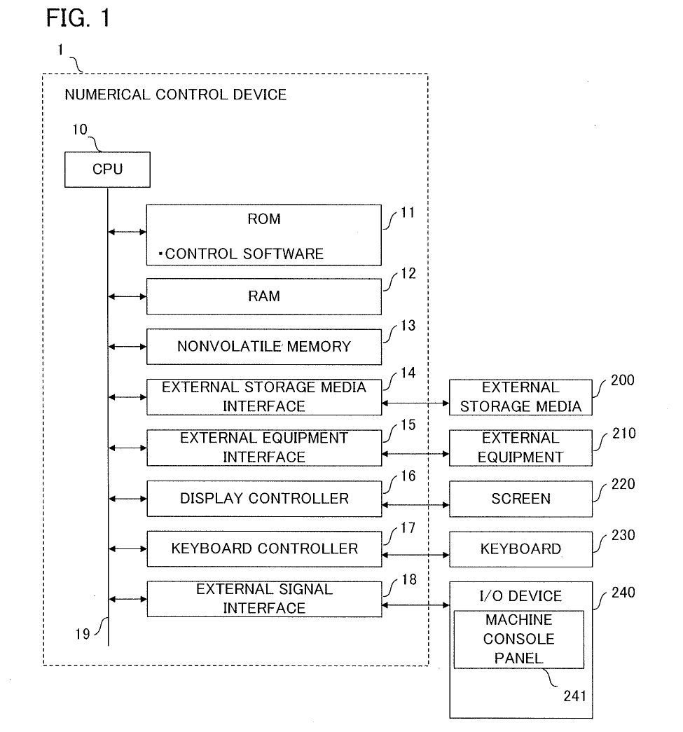

FIG. 1 is a schematic block diagram showing a numerical control device according to an embodiment of the present invention. The numerical control device 1 includes a CPU 10. The CPU 10 is connected via a bus 19 to a ROM 11, a RAM 12, a nonvolatile memory 13, an external storage media interface 14, an external equipment interface 15, a display controller 16, a keyboard controller 17, an external signal interface 18.

The ROM 11 stores a control software for entire control of the numerical control device 1 and full time record function. The RAM 12 stores a machining program to be used by the numerical control device 1 to control the machine. The machining program are stored in the nonvolatile memory 13, and is configured to be stored in the RAM 12 by reading out from the nonvolatile memory 13 at the time of the execution. The CPU 10 reads out the machining program from the RAM 12 and sequentially executes the machining program to control the machine. Temporary memory region is reserved in the RAM 12. The temporary memory region is used for image generation, necessary for implementing the full time record function, and encoding of the moving image.

The external storage media interface 14 is connected to an external storage media 200. The external equipment interface 15 enables connection with an external equipment 210 such as an adaptor. The machining program, various kinds of parameters and the like are stored in the external storage media 200 and the external equipment 210. These program and data are read in via each interface and stored in the RAM 12 and the nonvolatile memory 13 via the bus.

A display 220 such as a screen is connected to the display controller 16, and displays the status information of the numerical control and the controlling machine based on the display command from the CPU 10. The keyboard controller 17 is connected to a keyboard 230 and receives and transfers the command and the data input by the operator via the keyboard 230 to the CPU 10.

The external signal interface 18 is connected to the control object such as various kinds of actuators, a sensor, and a machine console panel 241 of the machining tool or the like, via an I/O device 240.

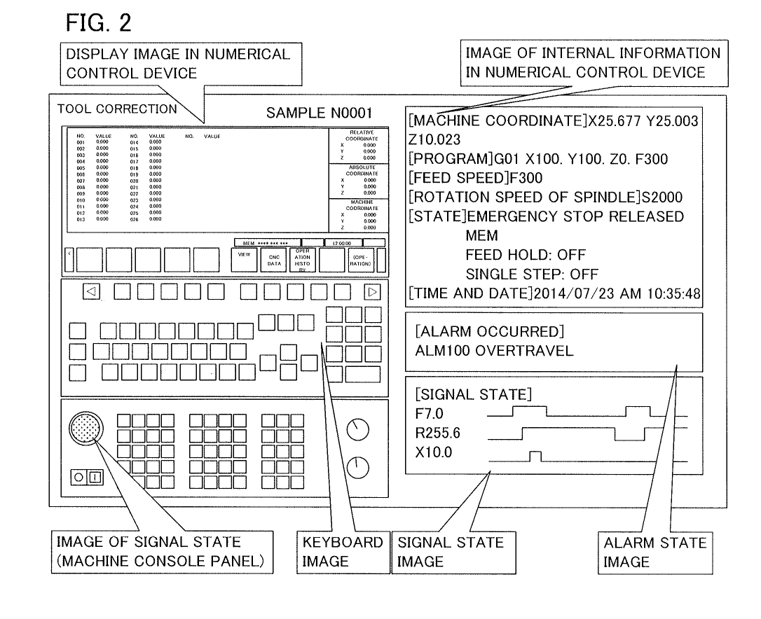

The numerical control device 1 according to the present embodiment has full time record function of combining a display image displayed on the display 220, an operation image of a keyboard 230, an operation image of a machine console panel 241, a display image of the occurring alarm, a display image of the signal state, and a display image of the internal information of the numerical control device 1, to an image and recording the images as a moving image. FIG. 2 is a display example of the moving image recorded by the numerical control device according to an embodiment of the present invention.

In FIG. 2, upper left part of the figure shows the display image displayed on the display 220, while lower left part of the figure shows the operation image of the keyboard 230 and the machine console panel 241. Right side of the figure shows the display image of the internal information of the numerical control device 1, the display image of the occurring alarm, and the display image of the signal state. Each of these images is sequentially generated as an individual image and combined to an image. Then plurality of the combined images are converted to a moving image in real time and recorded.

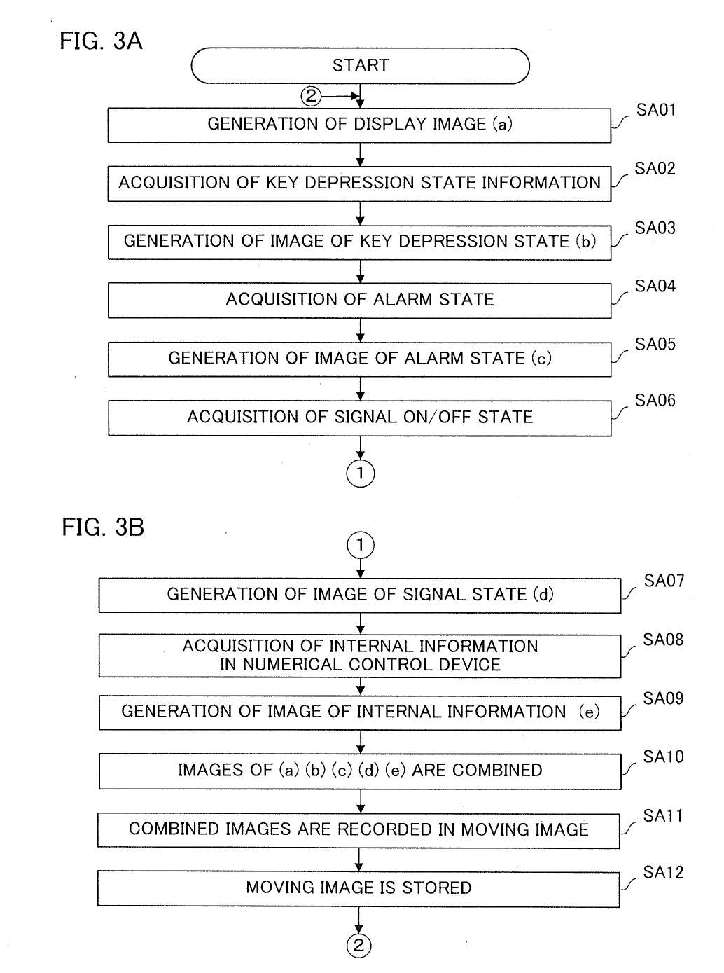

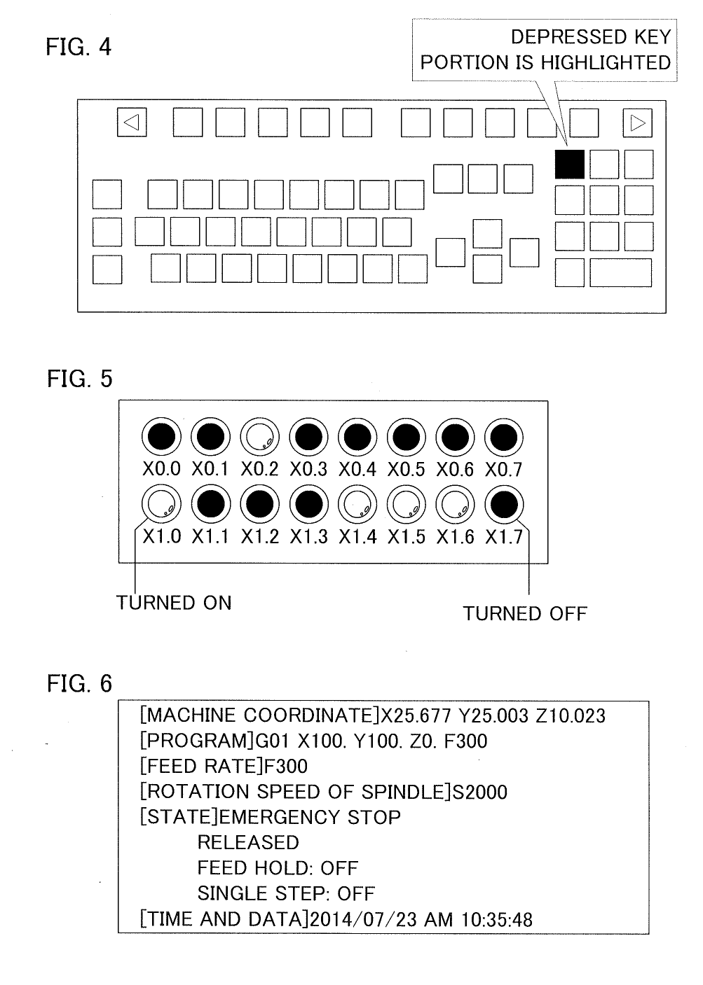

FIGS. 3A, 3B are flowcharts of the full time recording process, executed by the full time recording function. In the process, when the full time recording process is activated, the process is executed in a loop in a predetermined cycle of, 1/30 sec to 1/10 seconds, for example.

[Step SA01] The numerical control device 1 acquires the display data displayed on the display 220 of the numerical control device 1 and images the data. The image is generated based on the pixel data of the display generated by the display controller 16, and temporarily stored as an image file in BMP, JPG, GIF, or PNG format or the like.
[Step SA02] Depression state information of the keyboard 230 is acquired from the keyboard controller 17.
[Step SA03] The keyboard depression state acquired in Step SA02 is imaged. In order to generate the keyboard image, a keyboard image as a base of the keyboard image, a table which relates a depressed key to a coordinate information in the keyboard image, and the like, in the nonvolatile memory 13 or the like. Then, based on these information, the coordinate information in the keyboard image is acquired using the acquired key depression state. After that, the keyboard image in which the depressed key portion is highlighted as shown in FIG. 4 is generated, and temporarily stored as an image file in BMP, JPG, GIF, or PNG format or the like.
[Step SA04] Information of the alarm occurred in the numerical control device 1 is acquired.
[Step SA05] The alarm image is generated based on the information of the alarm acquired in Step SA04, and temporarily stored as an image file in BMP, JPG, GIF, or PNG format or the like.
[Step SA06] ON/OFF state of the signal of the I/O device 240 is acquired via the external signal interface.
[Step SA07] The signal state image is generated based on the information of the ON/OFF state of the signal acquired in Step SA06, and temporarily stored as an image file in BMP, JPG, GIF, or PNG format or the like. Examples of the image of the signal state include an image of the machine console panel shown in lower left part of FIG. 2, and a method of displaying the signal change in a graph with a lateral axis defined as a time axis as shown in lower right part of FIG. 2. In order to generate an image of the machine console panel, an machine console panel picture as a base of the machine console panel image, pictures of parts such as a lamp showing each signal state, a button, a selector switch, and coordinate information of each lamp, button, switch and the like on the machine console panel may be stored in the nonvolatile memory 13 or the like, and based on these information, the image of the machine console panel may be generated. History of Each signal state for a predetermined time may be stored in the RAM 12 or the like, and the image is generated based on the history and the signal state acquired this time, for drawing the graph of the signal state. The signal state history for a predetermined time may be recorded in the RAM 12 or the like such that the image may be generated base on the history and the signal state acquired this time, to draw the signal state as a graph. As shown in FIG. 5, the signal state may be represented by an image of LED lamp. More specifically, the I/O device with signal state ON may be represented by an image of a turned on light, while the I/O device with signal state OFF may be represented by an image of a turned off light.
[Step SA08] The internal information of the numerical control device 1 is acquired. The internal information includes information of each part managed in the numerical control machine, such as coordinate value of each servo axis, machining program under execution, feed rate, rotation speed of the spindle, time, operation mode, emergency stop state of the numerical control device.
[Step SA09] The image of the internal information of the numerical control device 1 is generated based on the internal information of the numerical control device acquired in Step SA08, and temporarily stored as an image file in BMP, JPG, GIF, or PNG format or the like. As the image of the internal information of the numerical control device 1, an image in which character strings representing the internal information as shown in FIG. 6 or the like, may be generated.
[Step SA10] The images, generated and temporarily stored in Steps SA01, SA03, SA05, SA07, SA09, are combined and the image as shown in FIG. 2 is generated.
[Step SA11] The moving image is generated based on the image generated in Step SA11. In order to generate the moving image from the images, the present image may be added to the end of the moving image previously generated in the full time recording process executed in the previous cycle, or images for predetermined number of cycles, generated in Step SA10, may be stored for generating partial motion image from the predetermined number of the images and combing the partial motion image to the end of the moving image previously generated. Here, appropriate codec of the moving image may be selected from Mpeg, Motion-JPEG, H.264 or the like, considering image quality required, CPU performance, and the like.
[Step SA12] The moving image generated in Step SA11 is recorded as a file in the nonvolatile memory 13, the external storage media 200, or the like. The file may be recorded in each cycle of this process, or in each of a predetermined number of periods. The moving image may be recorded in a file. Alternatively, the moving image may be recorded in a file while the file may be divided at an appropriate time. After Step SA12 is executed, the process returns to Step SA01 in the next cycle.

The moving image is always recorded during operation of the numerical control device 1, since the full time record, explained in FIG. 3, is executed in a loop of a predetermined number of cycles, as mentioned above. The file becomes huge if the moving image is stored as a file, and it is difficult to search the moving image at the time when the problem occurs among the entire moving image if the huge file is run for the investigation of the cause of the problem.

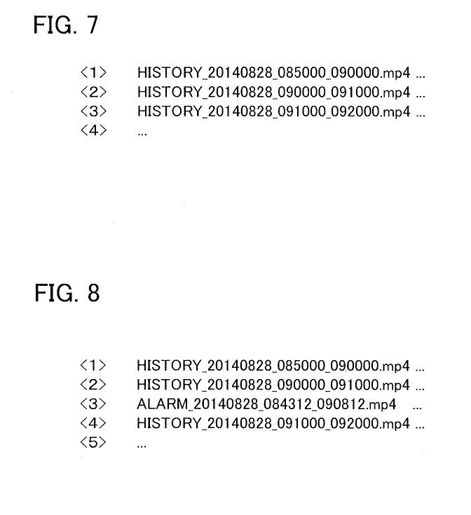

As one of the ideas for solving the problem above mentioned, the moving file may be recorded in a plurality of files while dividing the moving file in each predetermined time. For example, the recording time duration of the moving image is set to be ten minutes and the moving image is recorded in each file for the designated time as shown in FIG. 7, such that the moving image file, including the time zone wished to be analyzed, is checked and the investigation time can be reduced. Here, <1> shows a moving image from 8:50 to 9:00 on 28 Aug. 2014, <2> shows a moving image from 9:00 to 9:10 on 28 Aug. 2014, and <3> shows a moving image from 9:10 to 9:20 on 28 Aug. 2014. It should be noted that, when the file is divided by time, the system time in the numerical control device 1 may be acquired in Step SA12 shown in FIG. 3, and the name of the moving file to be recorded may be changed at each separation time.

When the alarm occurred during recording of the moving image, the moving image before and after the time when the alarm occurred may be carved out to be recorded in a different file as the moving image of the alarm occurrence time. When the time for the carving out is set to be, five minutes after the alarm occurrence and twenty minutes before the alarm occurrence, the moving image, from minus twenty minutes from the alarm occurrence to five minutes after the alarm occurrence, is curved out as the different file <3> as shown in FIG. 8. FIG. 8 shows an example where the alarm occurred at 9:03:12, and <1> shows a moving image from 8:50 to 9:00 on 28 Aug. 2014, <2> shows a moving image from 9:00 to 9:10 on 28 Aug. 2014, <1> shows a moving image from 8:50 to 9:00 on 28 Aug. 2014, <2> shows a moving image from 9:00 to 9:10 on 28 Aug. 2014, <4> shows a moving image from 9:10 to 9:20 on 28 Aug. 2014, and <3> shows a moving image from 8:43:12, twenty minutes before the alarm occurrence, to 9:08:12, five minutes after the alarm occurrence. <3> includes the alarm occurrence time of 9:03:12. With the way of recording mentioned above, the moving image including the time when the alarm occurs is easily specified, and convenience for the operator increases.

It should be noted that, existing library prepared in the numerical control device 1 or the like may be used for generation of the image, combination of the image, and generation of the moving image in the full time recording process explained using FIG. 3. It should be also noted that the images including the keyboard image and the signal image shown in the explanation of FIG. 3 is only an example, and any images, as far as the operator can grasp the state of the numerical control device 1 or the machine to be controlled by the view of the images, may be used.

In addition, an example where all of the display image of the screen, the keyboard image, the alarm state image, the signal state image, and the internal information image are combined to generate the moving image in the embodiment mentioned above. However it is possible for the operator to effectively use the moving image for investigating the problem occurred in the numerical control device, the machine, or the like, when at least the display image of the screen and the image of the input device including the keyboard image are combined and the moving image is generated from the combined image. In addition, additional information, selected based on the configuration of the numerical control device or the kind of the machine to be controlled, may be acquired and new image may be generated based on the acquired additional information, such that the new image is combine with the other image to be recorded as the moving image.

1. A numerical control device for recording status information indicating status at machine control, the numerical control device comprising:
a display image generation unit configured to generate a display image, the display image being generated by imaging a picture to be displayed on a screen;
a keyboard image generation unit configured to generate a keyboard image, the keyboard image being generated by acquiring key depression state information and imaging the acquired key depression state;
an image combination unit configured to combine the display image and the keyboard image into a combined image;
a moving image generation unit configured to generate a moving image based on the combined image generated periodically.

2. A numerical control device according to claim 1, further comprising at least one of,
an alarm state image generation unit configured to acquire information of occurring alarm and generate an alarm state image by imaging the acquired information of occurring alarm,
a signal state image generation unit configured to acquire ON/OFF state information of a signal and generate a signal state image by imaging the acquired ON/OFF state information of the signal, and
an internal information image generation unit configured to acquire internal information of the numerical control device and imaging the acquired internal information of the numerical control device, wherein
the image combination unit is further configured to combine at least one of the alarm state image, the signal state image, and the internal information image, with the display image and the keyboard image, to the combined image.

3. A numerical control device according to claim 1, wherein the moving image in each prescribed time is configured to be recorded as a video file.

4. A numerical control device according to claim 1, wherein the moving image before and after occurrence of alarm is configured to be recorded as a moving image file different from other moving image files.

5. A numerical control device according to claim 2, wherein the moving image in each prescribed time is configured to be recorded as a video file.

6. A numerical control device according to claim 2, wherein the moving image before and after occurrence of alarm is configured to be recorded as a moving image file different from other moving image files.

7. A numerical control device according to claim 3, wherein the moving image before and after occurrence of alarm is configured to be recorded as a moving image file different from other moving image files.

8. A numerical control device according to claim 5, wherein the moving image before and after occurrence of alarm is configured to be recorded as a moving image file different from other moving image files.
